(19) United States
(12) Patent Application Publication
(10) Pub. No.: US 2007/0114931 A1
(43) Pub. Date: May 24, 2007

(54) Flat panel display device

(76) Inventors: Seung-Hyun Son, Suwon-si (KR); Hyoung-Bin Park, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/602,880

(22) Filed: Nov. 21, 2006

(30) Foreign Application Priority Data
Nov. 22, 2005 (KR) 10-2005-0111985

(51) Int. Cl. H01J 9/02; H01J 1/00; H01J 1/16; H01J 17/49

(52) U.S. Cl. 313/582; 313/310; 313/311; 313/336

(57) ABSTRACT

Provided is a first substrate and a second substrate which face each other; a plurality of barrier ribs which define a space between the first and second substrates to form a plurality of cells and are located between the first and second substrates; a discharge gas filling the cells; a phosphor layer formed on the inner walls of the cells; a plurality of first electrodes formed on an inner surface of the first substrate; a plurality of second electrodes on an inner surface of the second substrate located in a direction crossing the first electrodes; a plurality of third electrodes formed on the first electrodes; and an electron accelerating layer which emits a first electron beam into the cells to excite the discharge gas when a voltage is applied to the first and third electrodes, and which is interposed between the first and third electrodes, wherein the electron accelerating layer is formed by printing an electron accelerating layer forming paste composition, drying the printed composition, and baking the dried composition, and contains at least one nanoparticle selected from a silicon nanoparticle and a conductive nanoparticle, and an insulating material.

### CROSS-REFERENCE TO RELATED PATENT APPLICATIONS

This application claims the benefit of Korean Patent Application No. 10-2005-0111985, filed on Nov. 22, 2005, in the Korean Intellectual Property Office, the disclosure of which is incorporated herein in its entirety by reference.

### BACKGROUND OF THE INVENTION

1. Field of the Invention

The present embodiments relate to a flat panel display device, and more particularly, to a flat panel display device which has low manufacturing costs, can be produced in large sizes, and includes an electron accelerating layer formed using an electron accelerating layer forming paste composition.

2. Description of the Related Art

Plasma display panels (PDPs) are a type of flat display device, and form an image using electrical discharge. PDPs have become popular due to their excellent display properties such as high brightness and wide viewing angle. PDPs emit visible light from a phosphor material which is excited by ultraviolet (UV) light generated from a gas discharge between electrodes, when DC and AC voltages are applied to the electrodes.

PDPs can be either facing discharge PDPs or surface discharge PDPs, according to the location of their electrodes. In the facing discharge structure, a pair of sustain electrodes are respectively located on a front substrate and a rear substrate, and a discharge is generated perpendicular to the substrates. In the surface discharge structure, a pair of sustain electrodes are located on the same substrate, and generate discharge parallel to the substrate.

FIG. 1 is an exploded perspective view of a conventional alternate current (AC) type surface discharge PDP. FIGS. 2A and 2B are cross-sectional views along horizontal and vertical lines of FIG. 1.

Referring to FIGS. 1, 2A, and 2B, a rear substrate 10 and a front substrate 20 faces each other and are separated by a predetermined distance such that a discharge space in which plasma discharge takes place, is formed therebetween. A plurality of address electrodes 111 are formed on the rear substrate 10 and are covered by a first dielectric layer 12. A plurality of barrier ribs 13, which divide the discharge space to define a plurality of discharge cells 14 and prevent electrical and optical cross-talk between the discharge cells 14, are formed on the upper surface of the first dielectric layer 12. Red, green, and blue phosphor layers 15 are coated on the inner walls of the discharge cells 14. The discharge cells 14 are filled with a conventional discharge gas containing Xe.

The front substrate 20 is transparent and is coupled to the rear substrate 10 on which the barrier ribs 13 are formed. In each of the discharge cells 14, a pair of sustain electrodes 21a and 21b are formed perpendicular to the address electrodes 11 on the lower surface of the front substrate 20. The sustain electrodes 21a and 21b are formed of a conductive material which can transmit visible light, such as indium tin oxide (ITO). To reduce the resistance of the sustain electrodes 21a and 21b, bus electrodes 22a and 22b narrower than the sustain electrodes 21a and 21b are formed of a metal on the lower surfaces of the sustain electrodes 21a and 21b. The sustain electrodes 21a and 21b and the bus electrodes 22a and 22b are covered by a transparent second dielectric layer 23. A protection layer 24 is formed of MgO on the lower surface of the second dielectric layer 23. The protection layer 24 prevents damage to the second dielectric layer 23 due to sputtering of plasma particles, and emits secondary electrons to reduce the discharge voltage.

The operation of the PDP having the above structure includes an operation for generating an address discharge and an operation for generating a sustain discharge. The address discharge occurs between the address electrode 11 and one of the pair of sustain electrodes 21a and 21b, and at this time, wall charges are formed. The sustain discharge is caused by a potential difference between the pair of sustain electrodes 21a and 21b, and generates discharge in the discharge gas, which generates UV light to excite a phosphor layer 15, thereby generating visible light. The visible light passes through the front substrate to form an image.

When a plasma discharge takes place in a conventional PDP, the discharged gas is ionized, and the excited Xe* generates UV light while stabilizing. Therefore the conventional PDP requires a high energy, sufficient to ionize the discharge gas. As a result, the conventional PDP requires a high driving voltage and exhibits low luminous

Korean Patent Application No. 2004-108412 discloses a flat panel display device which includes an electron accelerating layer, which generates an electron beam by accelerating electrons, and a grid electrode formed on the electron accelerating layer.

However, the flat panel display device disclosed in the above application cannot be produced in a large size, and has high manufacturing costs.

### SUMMARY OF THE INVENTION

The present embodiments provide a flat panel display device, a plasma display panel, having high luminous efficiency and a low operating voltage and being produced in large sizes, and an electron accelerating layer forming paste composition which is used to produce the devices.

According to an aspect of the present embodiments, there is provided a flat panel display device including: a first substrate and a second substrate which face each other and are separated from each other by a predetermined distance; a plurality of barrier ribs which define a space between the first and second substrates to form a plurality of cells and are located between the first and second substrates; a discharge gas filling the cells; a phosphor layer formed on the inner walls of the cells; a plurality of first electrodes formed on the inner surface of the first substrate; a plurality of second electrodes on the inner surface of the second substrate located in a direction crossing the first electrodes; a plurality of third electrodes formed on the first electrodes; and an electron accelerating layer which emits a first electron beam into the cells to excite the discharge gas when a voltage is applied to the first and third electrodes, and which is interposed between the first and third electrodes, wherein the electron accelerating layer is formed by printing an electron accelerating layer forming paste composition, drying the printed composition, and then baking the dried composition, and contains at least one nanoparticle selected from a silicon nanoparticle and a conductive nanoparticle, and an insulating material.

According to an aspect of the present embodiments, there is provided a plasma display device including: a first substrate that is transparent; a second substrate parallel to the first substrate; emission cells defined by barrier ribs between the first substrate and the second substrate; address electrodes extending in a direction in which the emission cells extend; a rear dielectric layer covering the address electrodes; a phosphor layer located in the emission cells; pairs of sustain electrodes extending in a direction crossing the address electrodes; a front dielectric layer covering the sustain electrodes; an electron accelerating layer located on a surface of the front dielectric layer; and a discharge gas in the emission cells, wherein the electron accelerating layer is formed by printing an electron accelerating layer forming paste composition, drying the printed composition, and baking the dried composition, and contains at least one nanoparticle selected from a silicon nanoparticle and a conductive nanoparticle, and an insulating material.

According to an aspect of the present embodiments, there is provided an electron accelerating layer forming paste composition used to produce a flat panel display device and including: at least one nanoparticle selected from a silicon nanoparticle and a conductive nanoparticle, an insulating material, a binder, and a solvent.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a conventional plasma display panel (PDP);

FIGS. 2A and 2B are sectional views, respectively along horizontal and vertical lines of the conventional PDP shown in FIG. 1;

FIGS. 3A and 3B are images of nanoparticles covered with an oxide film according to an embodiment;

FIG. 4 is a view of an electron emission source of an electron accelerating layer according to an embodiment;

FIG. 5 illustrates an electron emission mechanism of an electron accelerating layer according to an embodiment;

FIG. 6 is a sectional view of a flat panel display device according to an embodiment;

FIG. 7 is a graph of Xe energy levels;

FIG. 8 is sectional view of a flat panel display device according to another embodiment; and

FIG. 9 is an exploded perspective view of a PDP according to an embodiment.

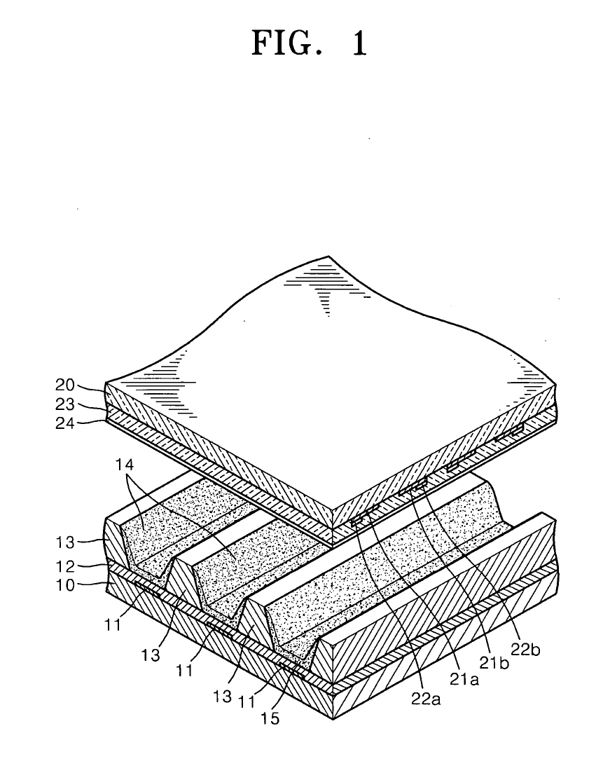

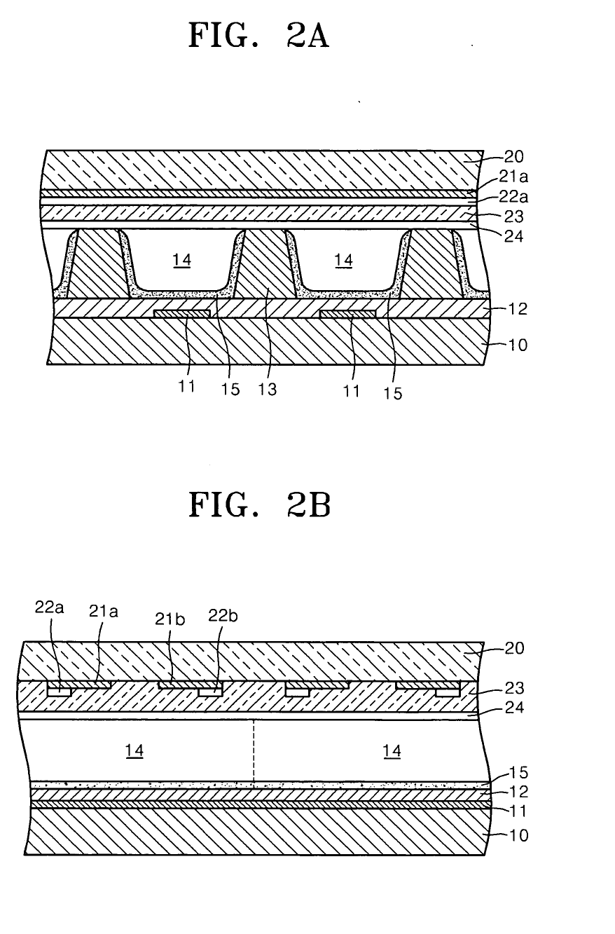

### DETAILED DESCRIPTION OF THE INVENTION

The present embodiments will now be described in detail with reference to the attached drawings.

The present embodiments provide a flat panel display device and a plasma display panel, each utilizing an accelerating electron source that can be processed in a paste state and is capable of multiple tunneling.

According to an embodiment, a paste composition can be formed into an electron accelerating layer through printing, drying, and baking processes. The paste composition includes: at least one nanoparticle selected from a silicon nanoparticle and a conductive nanoparticle, which emits electrons; an insulating material; a binder; and a solvent. The nanoparticle has a diameter of from about 5 to about 200 nm.

The nanoparticle is formed when an oxide film is formed, and reacts with a C₆-C₁₀ alcohol to form the oxide film. Since the amount of C₆-C₁₀ alcohol which reacts with the nanoparticle can be controlled, the size of the nanoparticle can be controlled.

The C₆-C₁₀ alcohol may be for example, hexyl alcohol, heptyl alcohol, octyl alcohol, capryl alcohol, nonyl alcohol, decyl alcohol or mixtures thereof.

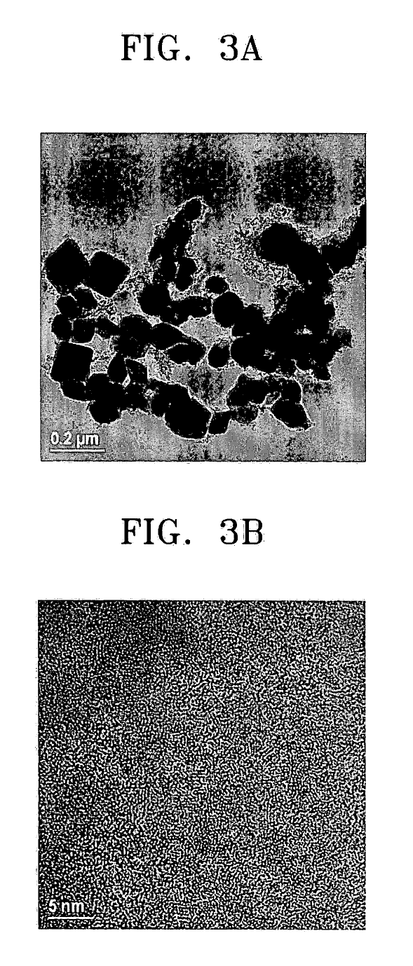

FIGS. 3A and 3B are images of nanoparticles covered with the oxide film. In FIG. 3A, the nanoparticles have an average diameter of about 200 nm. In FIG. 3B, the nanoparticles have an average diameter of about 5 nm. The nanoparticles are chemically synthesized, and the thickness of the oxide film covering the nanoparticles can be controlled by controlling the amount of reacting alcohol as described above. As a result, the size of the particles can be controlled.

According to an embodiment, an electron accelerating layer forming paste composition is used to produce a flat panel display device. The electron accelerating layer forming paste composition includes at least one nanoparticle selected from a silicon nanoparticle and a conductive nanoparticle, as well as an insulating material, a binder, and a solvent.

The binder may be an acrylate based polymer or a cellulose based polymer.

The organic solvent may include at least one material selected from the group consisting of terpinol, butyl carbitol acetate, toluene, butyl cellosolve, and texanol.

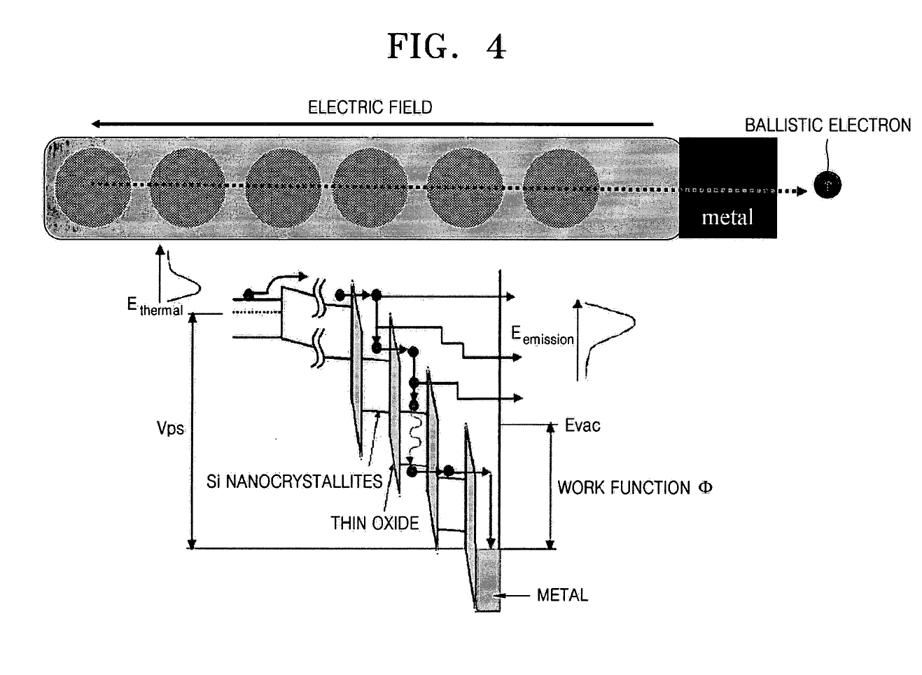

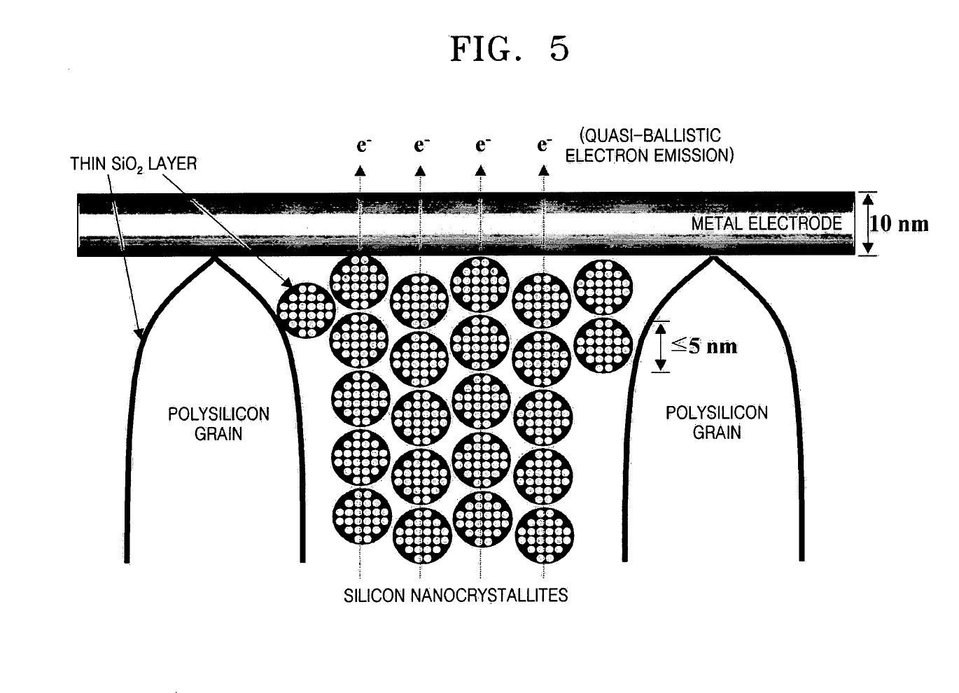

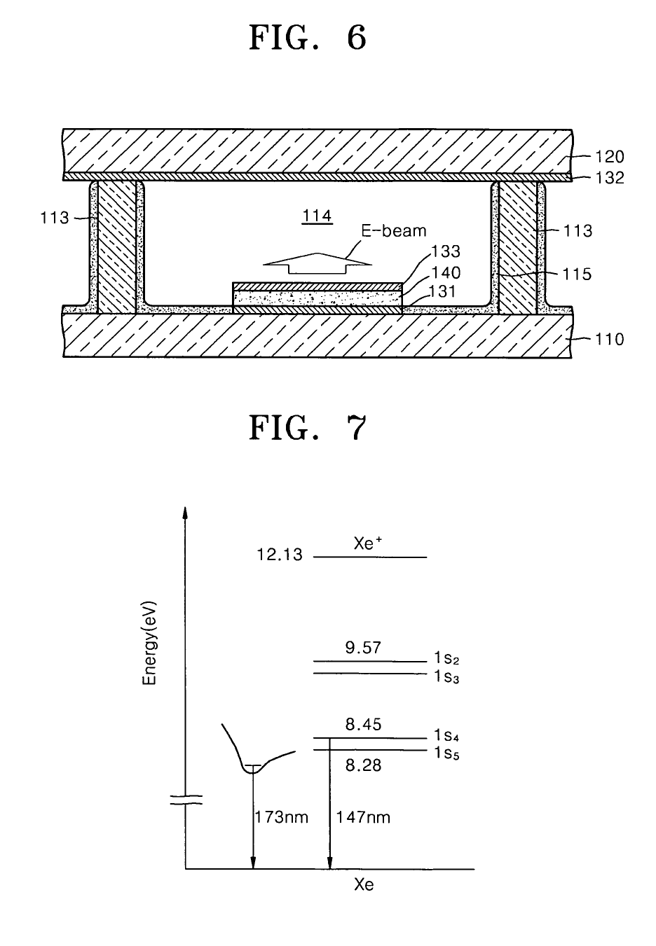

FIG. 4 is a view of an electron emission source formed of silicon nanocrystallites according to an embodiment. FIG. 5 illustrates an electron emission mechanism of an electron accelerating layer according to an embodiment. Referring to FIG. 5, electrons are excited by a lower electrode. The excited electrons are injected from the lower electrode to an electron accelerating layer. In the electron accelerating layer, the diameter of the silicon nanoparticles is sufficiently smaller than the average free path of electrons in the nanocrystallite. Therefore, relatively few electrons injected into the silicon nanoparticle collide with the silicon nanoparticle. That is, electrons arrive at an intersurface while passing the nanoparticles.

The silicon nanoparticles or conductive nanoparticles are covered with an oxide film, for example, an organic oxide layer. Therefore, the oxide film between the nanocrystallites catches the voltage applied, forming a strong field intensity region. Since the oxide layer is very thin, electrons easily pass through the oxide film by tunneling. Whenever electrons pass through strong field intensity regions, electrons are accelerated while moving toward a surface electrode. When electrons arrive in the vicinity of the surface electrode, the energy of the electrons may be almost equivalent to the applied voltage, which is much higher than a thermal equilibrium state. As a result, the electrons having high energy can pass through the surface electrode by tunneling toward the discharge gas.

According to an embodiment, an electron emission source having such a multiple tunneling effect is prepared through screen printing, which is suitable for a large-sized display having low manufacturing costs.

According to an embodiment, the silicon nanoparticle or the conductive nanoparticle is prepared using a physical method or a chemical method.

In the physical method, bulk silicon or conductive particles are pulverized by mechanical milling, and then the pulverized particles are physically blended. The diameter of the particles can be controlled by high temperature heat treatment. In this case, when the silicon nanoparticles are exposed to air, an oxide film is grown to a few nanometers. The covered silicon nanoparticles are dispersed with an insulating material, a binder, and a solvent to prepare a paste composition. However, in this physical method, it is difficult to obtain a uniform particle size and to reduce the particle size to less than a few nanometers.

In the chemical method, particle sizes can be controlled by chemical synthesis. As compared to the physical method, the chemical method is advantageous in that uniform particle sizes can be obtained and particle sizes can be reduced to less than a few nanometers. In addition, when silicon nanoparticles or conductive nanoparticles are synthesized, an organic material can be capped on the particles.

The electron accelerating layer forming paste composition according to an embodiment is screen printed, dried, and baked, thereby forming silicon nanoparticles or conductive nanoparticles covered with the insulating material on a substrate. The insulating material may be, for example, Al₂O₃, SiO₂, PbO, or glass frit.

FIG. 6 is a sectional view of a flat panel display device having a direct current facing discharge structure according to an embodiment. Referring to FIG. 6, a first substrate 110, which is a rear substrate, and a second substrate 120, which is a front substrate, are arranged to face each other with a constant distance therebetween. The first substrate 110 and the second substrate 120 can be formed, for example, of transparent glass. A plurality of barrier ribs 113, which divide a space between the first and second substrates 110 and 120 into a plurality of cells 114 and prevent electrical and optical cross-talk between the cells 114, are formed between the first and second substrates 110 and 120. Red (R), green (G), and blue (B) phosphor layers 115 are coated on the inner walls of the cells 114. The cells 114 are filled with a discharge gas containing, for example, Xe, N₂, D₂, H₂, CO₂, Kr or a mixture thereof. The discharge gas can generate ultraviolet (UV) light when excited by external energy such as an electron beam. The discharge gas used in the present embodiments can function as a discharge gas.

In each of the cells 114, a first electrode 131 extending in a direction is formed on the upper surface of the first substrate 110, and a second electrode 132 extending in a direction crossing the first electrode 131 is formed on the lower surface of the second substrate 120. Here, the first electrode 131 and the second electrode 132 are respectively a cathode electrode and an anode electrode. The second electrode 132 can be formed of a transparent conductive material, such as ITO, to transmit visible light. A dielectric layer (not shown) can further be formed on the second electrode 132.

An electron accelerating layer 140 is formed on the upper surface of the first electrode 131, and a third electrode 133, which is a grid electrode, is formed on the electron accelerating layer 140. The electron accelerating layer 140 can be formed by printing, drying, and baking the electron accelerating layer forming paste composition containing at least one nanoparticle selected from a silicon nanoparticle and a conductive nanoparticle, an insulating material, a binder, and a solvent. For example, the electron accelerating layer 140 may be formed of oxidized porous silicon.

The electron accelerating layer 140 emits an E-beam into the cell 114 through the third electrode 133 by accelerating electrons supplied by the first electrode 131 when a voltage is applied to the first electrode 131 and the third electrode 133. The E-beam emitted into the cell 114 excites the discharge gas, which generates UV light while stabilizing. The UV light excites the phosphor layer 115 to generate visible light, which is emitted toward the second substrate 120, thereby forming an image.

The E-beam preferably has an energy high enough to excite the discharge gas and low enough not to ionize the discharge gas. Therefore, a voltage applied to the first electrode 131 and the third electrode 133 should allow the E-beam to have the optimal electron energy to excite the discharge gas.

FIG. 7 is a graph showing energy levels of Xe, which is a UV light source. Referring to FIG. 7, about 12.13 eV of energy is required to ionize Xe, and more than about 8.28 eV is required to excite Xe. More specifically, 8.28 eV, 8.45 eV, and 9.57 eV are respectively required to excite Xe to 1S₅, 1S₄, and 1S₂ states. The excited Xe* generates UV light of approximately 147 nm while stabilizing. Excimer Xe₂* is generated by colliding the excited Xe* with Xe in a grounded state, and the Xe₂* generates UV light of approximately 173 nm while stabilizing.

Accordingly, in an embodiment, an E-beam emitted into the cell 114 by the electron accelerating layer 140 can have an energy of from about 8.28 to about 12.13 eV to excite the Xe. In this case, the E-beam may have an energy of from about 8.28 to about 9.57 eV or from about 8.28 to about 8.45 eV. Also, the E-beam may have an energy of from about 8.45 to about 9.57 eV.

When V₁, V₂, and V₃ represent the voltages applied respectively to the first electrode 131, the second substrate 120, and the third electrode 133, V₁<V₃<V₂. When these voltages are respectively applied to the electrodes, an E-beam is emitted into the cell 114 by the voltages applied to the first electrode 131 and the third electrode 133 through the electron accelerating layer 140.

The discharge gas may be, in addition to Xe, a gas that can generate UV light which has a long enough wavelength to pass through glass, such as N₂. Since discharge does not take place, a compound gas can be used. In addition, The display device using the electron accelerating layer may be less sensitive to gas contamination than a discharge display. Accordingly, the discharge gas can be, for example, Xe, N₂, D₂, H₂, CO₂, Kr or mixtures thereof.

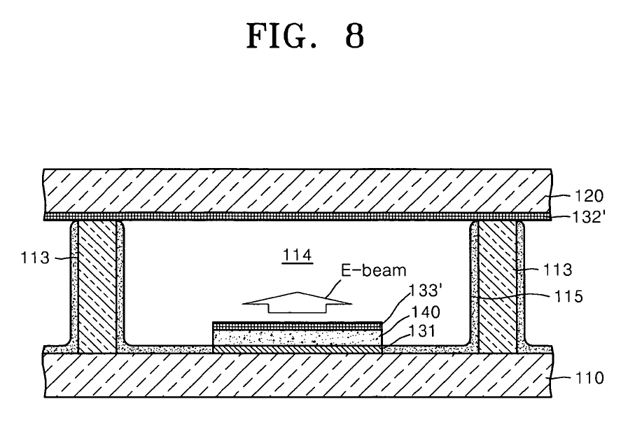

FIG. 8 is sectional view of a flat panel display device according to another embodiment. The differences from the flat panel display device shown in FIG. 6 will be described. Referring to FIG. 8, a second electrode 132′ is formed in a mesh structure so that visible light generated in the cells 114 can be transmitted. The third electrode 133′ is formed in a mesh structure so that electrons accelerated by the electron accelerating layer 140 can readily be emitted into the cells 114.

Hereinbefore, the first substrate 110 has referred to a rear substrate and the second substrate 120 has referred to a front substrate. However, the present embodiment can be applied to the case where the first substrate 110 on which the electron accelerating layer 140 is formed is the front substrate and the second substrate 120 is the rear lower substrate.

A plasma display panel according to another embodiment includes: a first substrate that is transparent; a second substrate parallel to the first substrate; emission cells defined by barrier ribs between the first substrate and the second substrate; address electrodes extending in a direction in which the emission cells extend; a rear dielectric layer covering the address electrodes; a phosphor layer located in the emission cells; a plurality of pairs of sustain electrodes extending in a direction crossing the address electrodes; a front dielectric layer covering the sustain electrodes; an electron accelerating layer located on a surface of the front dielectric layer; and a discharge gas in the emission cells, wherein the electron accelerating layer is formed by printing an electron accelerating layer forming paste composition, drying the printed composition, and baking the dried composition, and contains at least one nanoparticle selected from a silicon nanoparticle and a conductive nanoparticle, and an insulating material.

The electron accelerating layer forming paste composition includes at least one nanoparticle selected from a silicon nanoparticle and a conductive nanoparticle, an insulating material, a binder, and a solvent. The nanoparticle may have a diameter of from about 5 to about 200 nm.

The nanoparticle is formed when an oxide film is formed. Herein, the oxide film is formed by reacting the nanoparticle with a C₆-C₁₀ alcohol.

The C₆-C₁₀ alcohol may be for example, hexyl alcohol, heptyl alcohol, octyl alcohol, capryl alcohol, nonyl alcohol, the decyl alcohol or mixtures thereof.

The insulating material may be, for example, Al₂O₃, SiO₂, PbO, or glass frit.

The electron accelerating layer may be formed for example, of oxidized porous silicon.

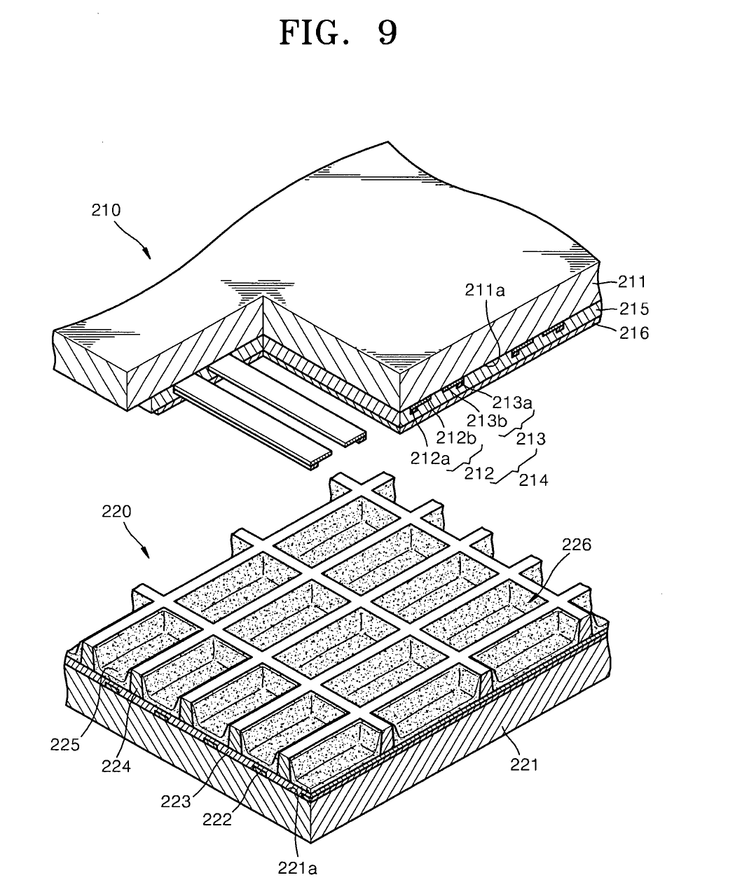

FIG. 9 is an exploded perspective view of a PDP 200 according to an embodiment. FIG. 9 shows the structure of a front panel 210 and a rear panel 220 of the PDP 200. The front panel 210 includes a front substrate 211, pairs of sustain electrodes 214 including Y electrodes 212 and X electrodes 213 on the rear surface 211a of the front substrate 211, a front dielectric layer 215 covering the pairs of sustain electrodes 214, and an electron accelerating layer 216 covering the front dielectric layer 215. The Y electrodes 212 and X electrodes 213 respectively include transparent electrodes 212b and 213b formed of, for example, ITO, and bus electrodes 212a and 213a formed of a conductive metal. The bus electrodes 212a and 213a are connected to connecting cables installed at opposite sides of the PDP 200.

The rear panel 220 includes a rear substrate 221, address electrodes 222 extending in a direction crossing the direction in which the sustain electrodes 214 extend, on the front surface 221a of the rear substrate 221, a rear dielectric layer 223 covering the address electrodes 222, barrier ribs 224 defining emission cells 226 on the rear dielectric layer 223, and a phosphor layer 225 formed on the emission cells 226. The address electrodes 222 are connected to connecting cables installed at opposite sides of the PDP 200.

As described above, in a flat panel display device and a PDP according to the present embodiments, an electron accelerating layer emits an E-beam that excites a discharge gas. The flat panel display device and PDP require low operating voltages and have high luminous efficiency.

As also described above, an acceleration emission source having a multiple tunneling effect can be processed in a paste state, so that a screen printing method can be used. When voltages are applied to both ends of the electron emission source, electrons undergo continuous multiple tunneling in an insulating material covering a conductive particle to be emitted. By using screen printing, a large-sized device can be produced with low manufacturing costs. According to the present embodiments, a large sized PDP having a low operating voltage and a high emission efficiency can be produced with low manufacturing costs.

While the present embodiments have been particularly shown and described with reference to exemplary embodiments thereof, it will be understood by those of ordinary skill in the art that various changes in form and detail may be made therein without departing from the spirit and scope of the present embodiments as defined by the following claims.

1. A flat panel display device comprising:
a first substrate and a second substrate which face each other and are separated from each other by a predetermined distance;
a plurality of barrier ribs which define a space between the first and second substrates to form a plurality of cells and are located between the first and second substrates;
a discharge gas filling the cells;
a phosphor layer formed on inner walls of the cells;
a plurality of first electrodes formed on an inner surface of the first substrate;
a plurality of second electrodes on an inner surface of the second substrate, located in a direction crossing the first electrodes;
a plurality of third electrodes formed on the first electrodes; and
an electron accelerating layer which emits a first electron beam into the cells to excite the discharge gas, when a voltage is applied to the first and third electrodes, and which is interposed between the first and third electrodes,
wherein the electron accelerating layer is formed by printing an electron accelerating layer forming paste composition, drying the printed composition, and baking the dried composition, and contains at least one nanoparticle selected from a silicon nanoparticle and a conductive nanoparticle, and an insulating material.

2. The flat panel display device of claim 1, wherein the nanoparticle has a diameter of from about 5 to about 200 nm.

3. The flat panel display device of claim 1, wherein the nanoparticle is covered with an oxide film.

4. The flat panel display device of claim 3, wherein the oxide film is formed by reacting the nanoparticle with a C₆-C₁₀ alcohol.

5. The flat panel display device of claim 4, wherein the C₆-C₁₀ alcohol is selected from the group consisting of hexyl alcohol, heptyl alcohol, octyl alcohol, capryl alcohol, nonyl alcohol, decyl alcohol and mixtures thereof.

6. The flat panel display device of claim 1, wherein the insulating material is selected from the group consisting of Al₂O₃, SiO₂, PbO, and glass frit.

7. The flat panel display device of claim 1, wherein the first electron accelerating layer is formed of oxidized porous silicon.

8. The flat panel display device of claim 1, wherein the second and third electrodes have mesh structures.

9. The flat panel display device of claim 1, wherein a dielectric layer is formed on the second electrodes.

10. The flat panel display device of claim 1, wherein the discharge gas comprises at least one of Xe, N₂, D₂, H₂, CO₂, and Kr.

11. The flat panel display device of claim 10, wherein the first electron accelerating layer has an energy of from about 8.28 eV to about 12.13 eV.

12. A plasma display panel comprising:
a first substrate that is transparent;
a second substrate parallel to the first substrate;
emission cells defined by barrier ribs between the first substrate and the second substrate;
address electrodes extending in a direction in which the emission cells extend;
a rear dielectric layer covering the address electrodes;
a phosphor layer located in the emission cells;
pairs of sustain electrodes extending in a direction crossing the address electrodes;
a front dielectric layer covering the sustain electrodes;
an electron accelerating layer located on a surface of the front dielectric layer; and
a discharge gas in the emission cells,
wherein the electron accelerating layer is formed by printing an electron accelerating layer forming paste composition, drying the printed composition, and baking the dried composition, and contains at least one nanoparticle selected from a silicon nanoparticle and a conductive nanoparticle, and an insulating material.

13. The plasma display panel of claim 12, wherein the nanoparticle has a diameter of from about 5 to about 200 nm.

14. The plasma display panel of claim 12, wherein the nanoparticle is covered with an oxide film.

15. The plasma display panel of claim 14, wherein the oxide film is formed by reacting the nanoparticle with a C₆-C₁₀ alcohol.

16. The plasma display panel of claim 15, wherein the C₆-C₁₀ alcohol is selected from the group consisting of hexyl alcohol, heptyl alcohol, octyl alcohol, capryl alcohol, nonyl alcohol, decyl alcohol and a mixture thereof.

17. The plasma display panel of claim 12, wherein the insulating material is selected from the group consisting of Al₂O₃, SiO₂, PbO, and glass frit.

18. The plasma display panel of claim 12, wherein the electron accelerating layer is formed of oxidized porous silicon.

19. An electron accelerating layer forming paste composition configured for use in a flat panel display device and comprising: at least one nanoparticle selected from a silicon nanoparticle and a conductive nanoparticle, an insulating material, a binder, and a solvent.

20. The composition of claim 19, wherein the binder is one of an acrylate based polymer and a cellulose based polymer.

21. The composition of claim 19, wherein the organic solvent is at least one material selected from the group consisting of terpinol, butyl carbitol acetate, toluene, butyl cellosolve, and texanol.
